(19) United States
(12) Patent Application Publication
(10) Pub. No.: US 2006/0238768 A1
(43) Pub. Date: Oct. 26, 2006

(54) Fourier transform infrared spectrometer

(75) Inventors: Stuart Brorson, Brighton, MA (US); Carl Brouillette, West Hartford, CT (US); Robert M. Carangelo, Glastonbury, CT (US); David F. Marran, Durham, CT (US)

Correspondence Address: PROSKAUER ROSE LLP, ONE INTERNATIONAL PLACE 14TH FL, BOSTON, MA, 02110, US

(73) Assignee: MKS Instruments, Inc., Wilmington, MA (US)

(21) Appl. No.: 11/115,039

(22) Filed: Apr. 26, 2005

(51) Int. Cl. G01B 9/02; G01J 3/45

(52) U.S. Cl. 356/451

(57) ABSTRACT

A method and apparatus for measuring radiometric signals. An infrared energy signal is directed through a sample and combined with a selected signal to reduce the effect of analog-to-digital converter nonlinearity. The combined signal is processed to, for example, accurately and repeatably identify the types of and concentration of molecules within the sample.

### FIELD OF THE INVENTION

The invention relates to methods and apparatus for measuring radiometric signals. More particularly, the invention relates to methods and apparatus for measuring radiometric samples to, for example, identify the presence and/or the concentration of molecules within a sample using a Fourier Transform Infrared (FTIR) spectrometer.

### BACKGROUND OF THE INVENTION

Spectroscopy is the study of the interaction between electromagnetic radiation and a sample (e.g., containing one or more of a gas, solid and liquid). The manner in which the radiation interacts with a particular sample depends upon the properties (e.g., molecular composition) of the sample. Generally, as the radiation passes through the sample, specific wavelengths of the radiation are absorbed by molecules within the sample. The specific wavelengths of radiation that are absorbed are unique to each of the molecules within the specific sample. By identifying which wavelengths of radiation are absorbed, it is therefore possible to identify the specific molecules present in the sample.

Infrared spectroscopy is a particular field of spectroscopy in which, for example, the types of molecules and the concentration of individual molecules within a sample are determined by subjecting the sample (e.g., gas, solid, liquid or combination thereof) to infrared electromagnetic energy. Generally, infrared energy is characterized as electromagnetic energy having wavelengths of energy between about 0.7 μm (frequency 14,000 cm⁻¹) and about 1000 μm (frequency 10 cm⁻¹). Infrared energy is directed through the sample and the energy interacts with the molecules within the sample. The energy that passes through the sample is detected by a detector (e.g., an electromagnetic detector). The detected signal is then used to determine, for example, the molecular composition of the sample and the concentration of specific molecules within the sample.

One particular type of infrared spectrometer is the Fourier Transform Infrared (FTIR) spectrometer. They are used in a variety of industries, for example, semiconductor processing and chemical production. Different applications for FTIR spectrometers require different detection sensitivity to enable a user to distinguish between which molecules are present in a sample and to determine the concentration of the different molecules. In some applications it is necessary to identify the concentration of individual molecules in a sample to within about one part in one billion. As industrial applications require increasingly better sensitivity, performance variability in spectrometers and in the hardware components of existing spectroscopy systems makes it difficult to repeatably resolve smaller and smaller concentrations of molecules in samples.

A common hardware component in spectroscopy systems as well as many modem electronics systems is the analog-to-digital converter. An analog-to-digital converter is a device that converts (digitizes or quantizes) continuous signals to discrete digital numbers. The resolution of the converter indicates the number of discrete values it can produce. It is usually expressed in bits. For example, an analog-to-digital converter that encodes an analog input to one of 1024 discrete values (quantization levels) has a resolution of 10 bits (2¹⁰=1024). Resolution can also be defined electrically, and expressed in volts. The voltage resolution of an ADC is equal to its overall voltage measurement range divided by the number of quantization levels.

It is desirable for the quantization levels to be perfectly evenly spaced in analog-to-digital converters. Design and manufacturing tolerances typically, however, limit the ability for the quantization levels to actually be evenly spaced. Rather, there is usually a deviation of the quantization levels from perfect, even spacing—a distortion known as analog to digital converter (ADC) nonlinearity. In the limit where the deviation is pattemless, and varies randomly from one bit (one quantization level) to the next, the distortion is called differential nonlinearity. In the limit where the deviation evinces a pattern over the entire input range of the ADC, the distortion is called integral nonlinearity. Between these two limits, some analog to digital converters can display a distortion characterized by a periodic, repeating deviation of the quantization levels (periodic nonlinearity) from perfect uniformity over the entire ADC input range. All forms of ADC nonlinearity adversely affect the measurement of radiometric signals. That is, any nonlinearity results in the analog-to-digital converter outputting digital signals that do not reflect the true value of the analog signal input into the analog-to-digital converter.

A need therefore exists for systems and methods that improve the performance of ADC-based systems for measuring radiometric signals, and more particularly spectroscopy systems.

### SUMMARY OF THE INVENTION

The invention, in one aspect, features a system for measuring radiometric signals. The system is based upon the FTIR spectrometer, which is well known to practitioners in the field of spectroscopy. It includes a source of infrared energy and a first module for splitting the infrared energy into a first and a second infrared signal. The system also includes a second module for creating a path length different in the first signal relative to the second signal. This path length difference is swept or varied in time, usually and desirably at a constant rate. The system also includes a third module for combining the first signal having a path length difference with the second signal to create an interference signal and to direct the interference signal through a sample (e.g., containing one or more of a solid, liquid and gas). The system also includes a fourth module for detecting the sample signal. Since the path length difference is swept in time, the detected sample signal will be a time-varying (i.e., time-domain) signal proportional to the intensity of the light falling on the detector at each instant in time. The system also includes a signal source that outputs a selected signal (e.g., a pre-defined or randomly defined dither signal) capable of reducing the effect of analog-to-digital converter nonlinearity on measured radiometric signals. The system also includes a fifth module that sums the detected sample signal and the selected signal. The system also includes an analog-to-digital converter that converts the combined detected sample signal and selected signal into a digital signal, and then processes the signal in such a way that the effect of nonlinearity is substantially reduced. In some embodiments, one or more of the modules are incorporated into a single module. The nonlinearity can be, for example, one or more of integral, differential, or periodic nonlinearity.

In some embodiments, the selected signal includes, for example, one or more of a sinusoidal signal, sawtooth signal, triangular signal, slow constant ramp signal, or a band-limited white noise signal. In some embodiments, the fundamental and harmonics of the selected signal are substantially outside a bandwidth of frequencies associated with the sample signal. In some embodiments, the selected signal has a mean amplitude of substantially zero. In some embodiments, the selected signal is determined during operation of the system (based on, for example, properties of the sample signal). In some embodiments, the analog-to-digital converter is, for example, an 18 bit analog-to-digital converter displaying a periodic nonlinearity with a repeat period corresponding to 9 bits (i.e., 512 quantization levels) of the 18 bit analog-to-digital converter. In some embodiments, the selected signal is a sinusoid having a magnitude determined by the period of the periodic nonlinearity. In some embodiments, the selected signal has a magnitude greater than or about equal to the magnitude corresponding to the period of the periodic nonlinearity. In some embodiments, the selected signal has a magnitude about twice as large as the magnitude corresponding to the period of the periodic nonlinearity.

In some embodiments, the system can include a sixth module that removes a signal equivalent to the selected signal from the digital signal to generate a second digital signal. The signal equivalent to the selected signal can be removed in the time domain or in the frequency domain. In some embodiments, a transformed signal equivalent to the selected signal does not substantially affect measurement of radiometric signals. In some embodiments, the fifth module sums or combines the sample signal and the selected signal. The sample can be, for example, one or more of a solid, liquid and gas.

The invention, in another aspect, features an apparatus for measuring radiometric signals that includes a source of radiant energy to direct radiant energy through a sample. The apparatus includes a first module for detecting the sample signal. The apparatus also includes an analog-to-digital converter. The apparatus also includes a signal source that outputs a selected signal capable of reducing the effect of nonlinearity of the analog-to-digital converter when combined with the sample signal and converted by the analog-to-digital converter to create a first digital signal.

In some embodiments, the apparatus includes a second module for converting the analog-to-digital converter signal to a frequency domain signal. In some embodiments, the conversion to the frequency domain signal is accomplished by a Fourier Transform (e.g., a Fast Fourier Transform). In some embodiments, the apparatus includes a third module that processes or correlates the frequency domain signal with a signal representative of a known material to identify the concentration of the known material in the sample. In some embodiments, the apparatus includes a third module for at least one of quantifying or qualitatively determining at least one property (e.g., concentration, temperature, pressure, and/or color) of the sample.

In some embodiments, the selected signal is a pre-defined signal. In some embodiments, the selected signal is determined during operation of the apparatus (e.g., the magnitude of the selected signal may be set using a potentiometer while monitoring the noise or fluctuations associated with the detected sample signal). In some embodiments, the apparatus includes a second module that removes a signal equivalent to the selected signal from the first digital signal to generate a second digital signal. The signal equivalent to the selected signal can be removed in the time domain or the frequency domain. In some embodiments, a transformed signal equivalent to the selected signal does not substantially affect measurement of radiometric signals.

In another aspect, the invention relates to a method for measuring radiometric signals (to for example, identify the concentration of molecules within a sample). The method involves splitting an infrared source signal into a first and second infrared signal and propagating the first and second infrared signals over different, adjustable path lengths (for example, where the path length difference is desirably swept at a constant rate in time). The method also involves combining the first and second propagated infrared signals to generate an interference signal. The method also involves directing the interference signal through a sample and detecting the sample signal. When the path length difference is swept in time, the detected sample signal is a time-domain signal. The method also involves combining a selected signal (e.g., a pre-defined or randomly defined dither signal) that is capable of reducing the effect of analog-to-digital converter nonlinearity on measured radiometric signals, with the detected sample signal to create a third signal. The method also involves converting the third signal into a digital signal in which the effect of nonlinearity is substantially reduced by further processing, such as taking a Fourier Transform or averaging the signal.

The selected signal can include, for example, one or more signals selected from the group consisting of one or more of a sinusoidal signal, sawtooth signal, triangular signal, slow constant ramp signal, and a band-limited white noise signal. In some embodiments, the method involves removing a signal equivalent to the selected signal from the digital signal to generate a second digital signal. In some embodiments, the method involves selecting a selected signal having a fundamental and harmonics substantially outside a bandwidth of frequencies associated with the sample signal. The selected signal can be a pre-defined signal. In some embodiments, the method involves determining the selected signal during operation. In some embodiments, the method involves removing a signal equivalent to the selected signal from the digital signal to generate a second digital signal. In some embodiments, the method involves removing a signal equivalent to the selected signal from the digital signal in the frequency domain to generate a second digital signal. In some embodiments, the method involves removing in the frequency domain a transformed signal equivalent to the selected signal from the digital signal to generate a second digital signal.

In another aspect, the invention relates to a method for measuring radiometric signals that involves directing radiant energy through a sample. The method also involves detecting the sample signal in the time domain. The method also involves combining a selected signal capable of reducing the effect of analog-to-digital converter nonlinearity on measured radiometric signals, with the detected signal to create a first signal. The method also involves converting the first signal into a time-domain digital signal which, when processed, will substantially reduce the effect of ADC nonlinearity.

In some embodiments, the method involves converting the digital signal into a frequency domain signal (by, for example, a Fourier Transform) In some embodiments, the method involves processing and correlating the frequency domain signal with a signal representative of a known material to identify the concentration of the known material in the sample. In some embodiments, the method involves at least one of quantifying or qualitatively determining at least one property of the sample. The method can involve pre-defining the sample signal or selecting the selected signal during operation.

In some embodiments, the method involves removing a signal equivalent to the selected signal from the digital signal to generate a second digital signal. In some embodiments, the method involves removing in the time domain a signal equivalent to the selected signal from the digital signal to generate a second digital signal. In some embodiments, the method involves removing in the frequency domain a signal equivalent to the selected signal from the digital signal to generate a second digital signal. In some embodiments, the method involves averaging the digital signal measured at two or more different times.

The invention, in one embodiment, features an apparatus for measuring radiometric signals. The apparatus includes a source of infrared energy and a first means for splitting the infrared energy into a first and second signal. The apparatus also includes a second means for creating a time-varying, variable path length difference in the first signal relative to the second signal. The apparatus also includes a third means for combining the first signal having a path length difference with the second signal to create an interference signal and to direct the interference signal through a sample. The apparatus also includes a fourth means for detecting the sample signal. The apparatus also includes a fifth means for outputting a selected signal capable of reducing analog-to-digital converter nonlinearity on measured radiometric signals and a sixth means for combining (e.g., summing or combining) the detected sample signal and the selected signal. The apparatus also includes an analog-to-digital converter that converts the combined detected sample signal and selected signal into a digital signal with which the effect of nonlinearity is substantially reduced upon processing.

The invention, in another aspect, relates to apparatus and methods for improving the accuracy of analog-to-digital converters. The method involves combining a selected signal that is capable of reducing the effect of analog-to-digital converter nonlinearity, with an analog signal that is to be converted by an analog-to-digital converter. The characteristics of the first signal are selected so that a fundamental and harmonics of the selected signal are substantially outside a bandwidth of frequencies associated with the analog signal. The method also involves directing the combined signal to an input of an analog-to-digital converter and converting the combined signal into a digital signal.

In some embodiments, the selected signal is one or more signals selected from the group consisting of a sinusoidal signal, sawtooth signal, triangular signal, slow constant ramp, and a band-limited white noise signal. In some embodiments, the bandwidth of frequencies is a pre-determined bandwidth of frequencies. In some embodiments, the selected signal is summed or combined with the analog signal. In some embodiments, the selected signal is a pre-defined signal. Alternatively, in some embodiments, the selected signal is determined during operation.

The foregoing and other objects, aspects, features, and advantages of the invention will become more apparent from the following description and from the claims.

### BRIEF DESCRIPTION OF THE DRAWINGS

The foregoing and other objects, feature and advantages of the invention, as well as the invention itself, will be more fully understood from the following illustrative description, when read together with the accompanying drawings which are not necessarily to scale.

FIG. 1 is a schematic view of a Fourier Transform Infrared spectrometer system that embodies the invention.

FIG. 2A is a graphical representation of a continuously varying signal and the discrete representation of the signal as converted by a digital-to-analog converter.

FIG. 2B is a graphical representation of periodic nonlinearity in an analog-to-digital converter.

FIG. 2C is a graphical representation of a selected signal summed with a continuously varying signal in the presence of periodic nonlinearity in an analog-to-digital converter.

FIG. 3A is a graphical representation of average concentration of Nitric Oxide (NO) as a function of time using a FTIR spectrometer system in the absence of a selected signal.

FIG. 3B is a graphical representation of average concentration of Nitric Oxide (NO) as a function of time using a FTIR spectrometer system, in the presence of a selected signal, according to the invention.

FIG. 4A is a graphical representation of a spectrum computed by a Fourier Transform Infrared spectrometer. Visible is the spectrum of the source, with various absorption bands caused by molecules present in the sample under study. The selected signal (dither) is absent in this figure.

FIG. 4B is a graphical representation of a spectrum computed by a Fourier Transform Infrared spectrometer, in the presence of a selected signal (dither), according to the invention.

### DETAILED DESCRIPTION OF ILLUSTRATIVE EMBODIMENTS

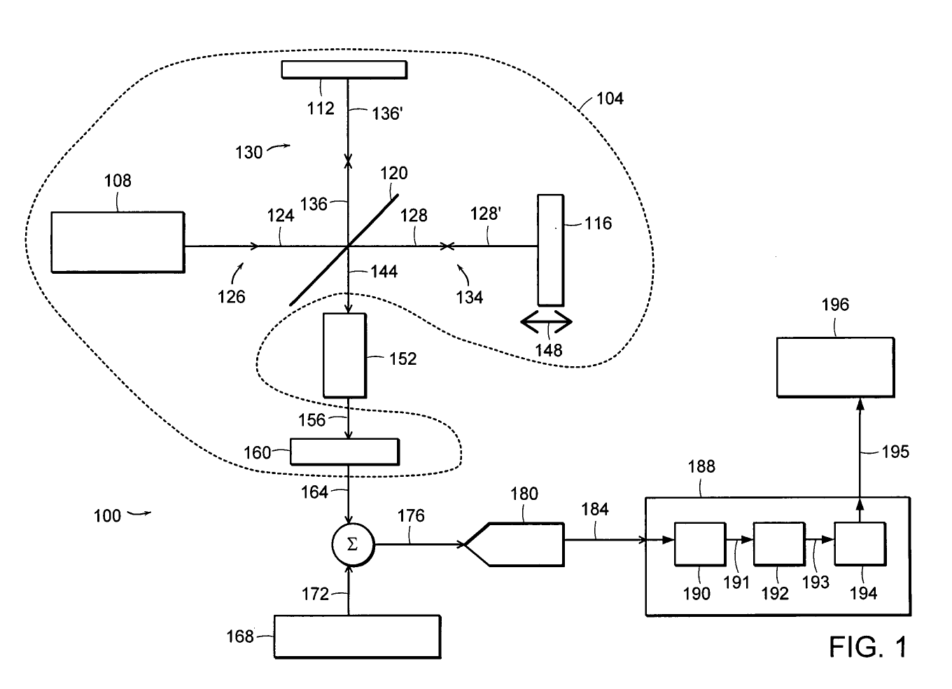

FIG. 1 is a schematic representation of a system 100 for measuring radiometric signals that embodies the invention. This schematic representation is based upon a Fourier Transform Infrared (FTIR) spectrometer, a type of optical instrument well known to workers in the field of optical spectroscopy. The system 100 includes, in part, an interferometer module 104 (e.g., a Michelson interferometer) and a sample 152 (e.g., containing one or more of a solid, liquid and gas). The interferometer 104 includes a source of electromagnetic energy 108 (or radiant energy), a fixed mirror 112, a movable mirror 116, an optics module 120, and a detector module 160 (e.g., an infrared energy detector). The interferometer module 104 measures all optical frequencies produced by the source 108 and transmitted through the sample 152. The source 108 produces electromagnetic energy 124 which is directed to the optics module 120 (commonly a beamsplitter). The optics module 120 splits the electromagnetic energy into two beams, a first signal 128 and a second signal 136. The movable mirror 116 creates a variable path length difference between these two initially, substantially identical beams of electromagnetic energy. The movable mirror 116 is normally moved or swept at a constant velocity. After the first signal 128 travels a different distance (in this embodiment, due to movement of the movable mirror 116) than the second signal 136, the first and second signals 128′ and 136′ are recombined by the optics module 120, producing a radiometric signal 144 whose intensity is modulated by the interference of the two beams 128′ and 136′. This interference signal 144 is passed through the sample 152 and measured by the detector 160. The presence of different samples 152 (e.g., solid, liquid, or gas) will modulate the intensity of the radiation as detected by the detector 160. The output of the detector 160 is therefore a variable, time-dependent signal depending upon the optical path difference established by the relative positions of mirrors 112 and 116, as well as the modulation of the electromagnetic signal produced by the sample 152. This output signal is known as an “interferogram.”

The interferogram signal can be represented as a plot of received energy intensity versus position of the movable mirror 116. Those skilled in the art refer to the interferogram as a signal that is a function of time. The interferogram is a function of the variable optical path difference produced by the moving mirror's displacement. Since the moving mirror's position is normally and desirably swept at a constant velocity, those skilled in the art refer to the interferogram as a “time domain” signal. The interferogram can be understood to be a summation of all the wavelengths of energy emitted by the source 108 and passed through the sample 152. Using the mathematical process of Fourier Transform (FT), a computer or processor converts the interferogram into a spectrum that is characteristic of the light absorbed or transmitted through the sample 152. Because individual types of molecules absorb specific wavelengths of energy, it is possible to determine the type of molecules (e.g., NO, HF and HCl) contained within a particular sample based on the interferogram and the corresponding spectrum. In a similar manner, the magnitude of the energy absorbed by or transmitted through the sample may be used to determine the concentration of the particular molecules within the sample.

In this embodiment, the system 100 is a Fourier Transform Infrared (FTIR) spectrometer and the source of electromagnetic energy 108 is a source of infrared energy. The energy source 108 directs an infrared energy signal 124 along a path 126 towards the optics module 120. The optics module 120 splits the infrared energy signal 124 into the first signal 128 and the second signal 136. The portion of the optics module 120 that splits the infrared energy signal 124 into two initially, substantially identical signals (signals 128 and 136) is generally referred to as a beam splitter.

The second signal 136 is directed along a path 130 towards the fixed mirror 112. The second signal 136 impinges on the surface of the fixed mirror 112 producing a reflected second signal 136′. The first signal 128 is directed along a path 134 towards the movable mirror 116. The movable mirror 116 is commanded to move along a direction 148. The movable mirror 116 may be commanded to move by, for example, a computer connected to an actuator (not shown) that is coupled to the movable mirror 116. The direction of movement 148 of the movable mirror 116 is parallel to the path 134 along which the first signal 128 is directed. The first signal 128 impinges on the surface of the movable mirror 116 producing a reflected first signal 128′. Movement of the movable mirror 148 creates a path length difference in the reflected first signal 128′ relative to the reflected second signal 136′.

In this embodiment, the optics module 120 includes optical components (e.g., mirrors and lenses) to combine the first reflected signal 128′ with the second reflected signal 136′ to produce an interference signal 144. In some embodiments, the functions of the optics module 120 are performed by two or more separate modules. For example, one optics module may be a beamsplitter, which splits the infrared energy signal 124 into the first signal 128 and the second signal 136. A second optics module may combine the first reflected signal 128′ with the second reflected signal 136′ to produce the interference signal 144.

The interference signal 144 is directed through the sample 152 (e.g., one or more of a gas, liquid, and solid). The interference signal 144 interacts with individual molecules within the sample 152 and exits the sample 152 as a sample signal 156. The natural vibration frequencies of the individual molecules within the sample 152 alter the characteristics of the interference signal 144 as the interference signal 144 passes through the sample 152 thereby producing the sample signal 156. It should be understood by those skilled in the art that the sample signal 156 carries the signature of the sample molecule's vibration frequencies, but at a slow rate (typically in the Hz-kHz range) determined by the velocity at which the optical path length difference is swept by the moving mirror 116.

The detector 160 (e.g., an electromagnetic detector) then detects the sample signal 156. The detector 160 outputs a detected sample signal 164 in response to detecting the sample signal 156. The system 100 also includes a signal source 168 that outputs a selected signal 172 (e.g., a dither signal) that is combined (e.g., summed or combined) with the detected sample signal 164 (detector sample signal). The combined signal 176 (combination of the selected signal 172 and the detected sample signal 164) is directed to an input of an analog-to-digital converter 180. The analog-to-digital converter 180 converts the combined signal 176 into a digital signal 184 that is directed to an analysis module 188.

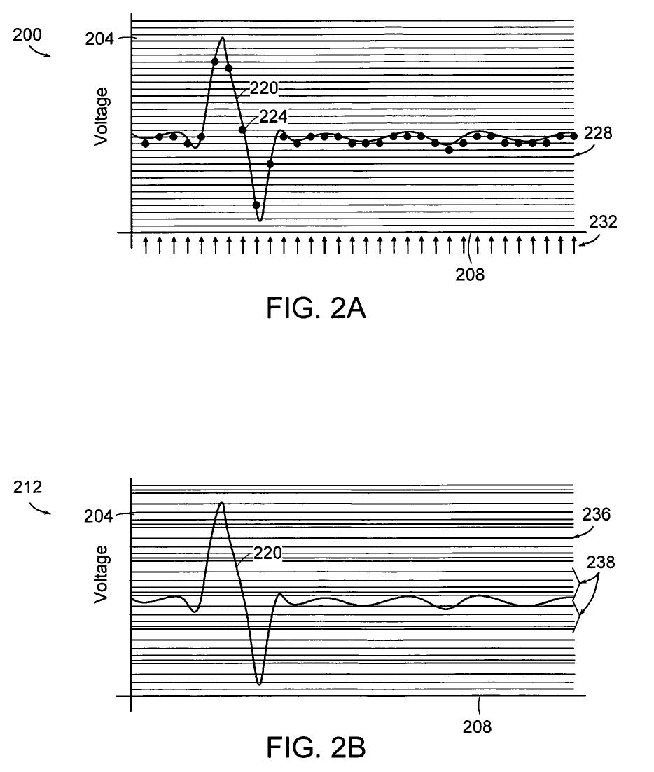

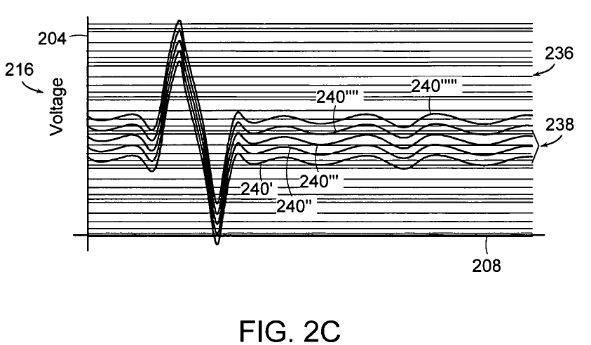

The selected signal 172 is capable of reducing the effect of analog-to-digital converter nonlinearity, for example, the periodic nonlinearity described with respect to FIGS. 2A, 2B, and 2C. By way of illustration, FIGS. 2A, 2B and 2C graphically depict the digitization process in an analog-to-digital converter, such as the analog-to-digital converter 180 of FIG. 1. In this case, ADC errors are exhibited as periodic nonlinearity. FIGS. 2A, 2B and 2C also graphically depict the effect of summing a dither signal (e.g., the selected signal 172 of FIG. 1) and an analog signal. The sum of the two signals is input to the analog-to-digital converter (e.g., analog-to-digital converter 180). FIG. 2A illustrates a graph 200 of a continuously varying signal 220 and the discrete signal values 224 (depicted as discrete points) of the signal 220. The signal 220 is converted by the analog-to-digital converter into the series of discrete signal values 224. The Y-Axis 204 of the graph 200 is voltage magnitude. The X-Axis 208 of the graph 200 is proportional to the optical path length difference established by the fixed mirror 112 and the moving mirror 116. As discussed above, this quantity is understood to correspond to time.

The horizontal spacing between each of the discrete signal values 224 is specified by the sampling rate of the analog-to-digital converter. In this embodiment, the discrete signal values 224 are samples of the continuously varying signal 220 taken by the analog-to-digital converter at uniformly spaced time intervals 232. The magnitude of the discrete signal values 224 correspond to the quantization levels 228 associated with the analog-to-digital converter. FIG. 2A depicts quantization levels 228 that are uniformly spaced along the Y-Axis 204 (voltage). The analog-to-digital converter outputs the magnitude (voltage) that is associated with a quantization level 228 closest to but not greater than the actual magnitude of the signal 220 at a specific time interval 232.

In practice, however, the quantization levels are not generally uniformly spaced along the Y-Axis 204. FIG. 2B illustrates a graph 212 in which the quantization levels 236 are not uniformly spaced along the Y-Axis 204. The graph 212 depicts the continuously varying signal 220 in which the Y-Axis 204 is voltage magnitude and the X-Axis 208 is proportional to the optical path length difference established by the fixed mirror 112 and the moving mirror 116. As discussed above, this quantity is understood to correspond to time. Accordingly, the analog-to-digital converter would convert the continuously varying signal 220 into a series of discrete signal values that would be different than the discrete signal values 224 in, for example, FIG. 2A. In some embodiments, the quantization levels 236 are non-uniform and exhibit a periodicity (as illustrated in FIG. 2B) in which the spacing between quantization levels repeats, for example, every five (5) quantization levels (shown as grouping 238). It is this non-uniformity and periodicity which can adversely affect the measurement of radiometric signals. By way of example, the methods and systems incorporating principles of the invention may be used to reduce the effect of various nonlinearities associated with ADC-based systems. The nonlinearity may, for example, be one or more of a differential, integral, or periodic nonlinearity.

FIG. 2C illustrates a graph 216 in which a selected signal (e.g., a sinusoidal dither signal) has been combined (as described in, for example, FIG. 1) with a continuously varying signal, such as the continuously varying signal 220 of FIGS. 2A and 2B. In this embodiment, the summed signal is measured at five different times producing five different dithered signals 240′, 240″, 240″′, 240″″, and 240″″′ (generally 240). An analog-to-digital converter converts each of the dithered signals 240 into a corresponding digital signal. The digital signals corresponding to each of the dithered signals 240 are then directed to, for example, the analysis module 188 (FIG. 1) for further processing.

In some embodiments, the dithered signals 240 are averaged prior to being directed to the analysis module 188. In some embodiments, each of the dithered signals is processed separately and then averaged prior to subsequent processing by the analysis module 188. In either case, averaging the dithered signals tends to average out the effect of the periodic nonlinearity. Systems and methods that incorporate the principles of the invention may be used, generally, to improve the performance of other ADC-based systems (e.g., pressure measurement systems, consumer electronics products).

In some embodiments, the selected signal 172 is a sinusoidal signal. Alternatively, the selected signal 172 may be, for example, a sawtooth signal, triangular signal, slow constant ramp signal, or a band-limited white noise signal. In some embodiments, the selected signal 172 has a substantially zero mean amplitude. By way of example, the signal source 168 may be a commercially available function generator or a custom electrical circuit capable of producing the selected signal 172. In some embodiments, the signal source 168 may be controlled by an operator or by a processor (e.g., a computer) to vary properties (e.g., frequency, amplitude, bandwidth, and energy content) of the selected signal 172. In some embodiments, properties of the selected signal 172 are chosen based on properties (e.g., frequency, amplitude, bandwidth, and energy content) of the sample signal 164.

Properties of the selected signal 172 are chosen (by, for example, an operator) generally to minimize the interaction between the selected signal 172 and the detected sample signal 164. By way of example, if the selected signal 172 is a sinusoidal signal, the fundamental frequency and harmonics of the sinusoid are selected to be greater than the natural frequencies associated with the individual molecules within the sample 152. In some embodiments, the fundamental frequency and harmonics are selected to be substantially outside a bandwidth of frequencies associated with the sample signal 164. In this manner, the system 100 minimizes the interaction between the selected signal 172 and the detected sample signal 164.

By way of example, in one embodiment the analog-to-digital converter 180 is an 18 bit analog-to-digital converter with a full scale reference voltage of about 5 volts. The periodicity of the nonlinearity associated with the exemplary 18 bit analog-to-digital converter corresponds to 9 bits of the full 18 bits of the analog-to-digital converter. In this embodiment, the selected signal is a sinusoidal signal with a magnitude equal to about 9.8 mvolts (9 bits out of 18 bits corresponds to about 9.8 mvolts out of 5 volts). In this embodiment, the magnitude (9.8 mvolts) of the selected signal is about equal to the magnitude (9 bits) associated with the period of the periodic nonlinearity in the analog-to-digital converter. In this embodiment, the 9.8 mvolt sinusoid substantially reduces the effect of analog-to-digital periodic nonlinearity on radiometric signals measured with the system, for example, the system 100 of FIG. 1).

Referring to FIG. 1, as previously described, the digital signal 184 is directed to the analysis module 188. The analysis module 188 is capable of being used for both qualitative and quantitative analysis of one or more properties of the sample 152. By way of example, the analysis module 188 can determine one or more properties (e.g., types of molecules, concentration, gas or fluid pressure, temperature and/or color) of the sample 152 or molecules within the sample 152.

In this embodiment, the analysis module 188 identifies the concentration of a particular material within the sample 152 based on the digital signal 184. The analysis module 188 may be, for example, signal processing hardware and quantitative analysis software that runs on a personal computer which is capable of processing the various signals of the system 100. In one embodiment, the analysis module 188 is one or more portions of a model 2030 Multigas Continuous Gas Analyzer (MKS Instruments, Inc., Wilmington, Mass.). The Gas Analyzer is capable of, for example, continuously acquiring and processing spectra while computing the concentration of multiple gases within a sample. The Gas Analyzer is capable of displaying concentration time histories in graphical and tabular formats and measured spectrum and spectral residuals. The Gas Analyzer is also capable of collecting and saving various data for reprocessing or review at a later time.

By way of example, the particular material that the analysis module 188 is intended to identify may be one that is known to be in a gas stream that is emitted from a piece of industrial equipment. It may be desirable to identify the type of material and/or concentration of the material within the gas stream. The analysis module 188 performs a variety of functions and mathematical calculations to determine the type of material and the concentration of the particular material within the sample 152. Each of the functions and calculations may be performed by one or more modules.

In this embodiment, the digital signal 184 is directed to a module 190 that removes from the digital signal 184 a signal that is equivalent to the selected signal 172 to generate a second digital signal 191. The second digital signal 191 is then directed to a module 192 that transforms the second digital signal 191 into a resultant signal by, for example, a Fourier Transform, such as a Fast Fourier Transform (in a manner that is well known in the art) The resultant signal is directed to a module 194. Module 194 processes the signal 193 in conjunction with a signal representative of the particular material to be identified. The resultant of the processing is a signal 195 that is representative of the concentration of the known material within the sample 152. The signal 195 is then, for example, observed or reviewed by an operator with a processor 196 (e.g., a computer). The signal 195 may be viewed, for example, as a series of data or as a graphical representation of the data.

In this embodiment, the signal that is equivalent to the selected signal 172 (described above) is removed from the digital signal 184 in the time domain. In some embodiments, however, the signal that is equivalent to the selected signal 172 is instead a transformed signal (transformed into the frequency domain) and removed from the resultant signal 193 in the frequency domain.

By way of illustration, an experiment was conducted to determine the average concentration of Nitric Oxide (NO) in a gas sample in a tank. The flow rate of the Nitric Oxide through the tank was about 0.2 liters/minute. The experiment was set up such that the average concentration of Nitric Oxide in the tank was a fixed value of about 3020 parts-per-million (ppm) over an eight hour period of time. The Fourier Transform Infrared (FTIR) spectrometer system (as described, for example, in FIG. 1) used to measure the concentration of the gas sample in the tank was a Multigas Continuous Gas Analyzer model 2030 (MKS Instruments, Inc., Wilmington, Mass.). The detector 160 was a one mm liquid N₂ cooled Mercury Cadmium Telluride infrared energy detector with a long wavelength cutoff of about 21 microns. The signal source 168 was a custom-designed pre-amplifier circuit that incorporates a pure sine wave oscillator. The circuit replaced a standard pre-amplifier circuit within the model 2030 Gas Analyzer. A jumper was installed in the Gas Analyzer to permit an operator to selectively turn on and off the selected signal 172 during the experiment.

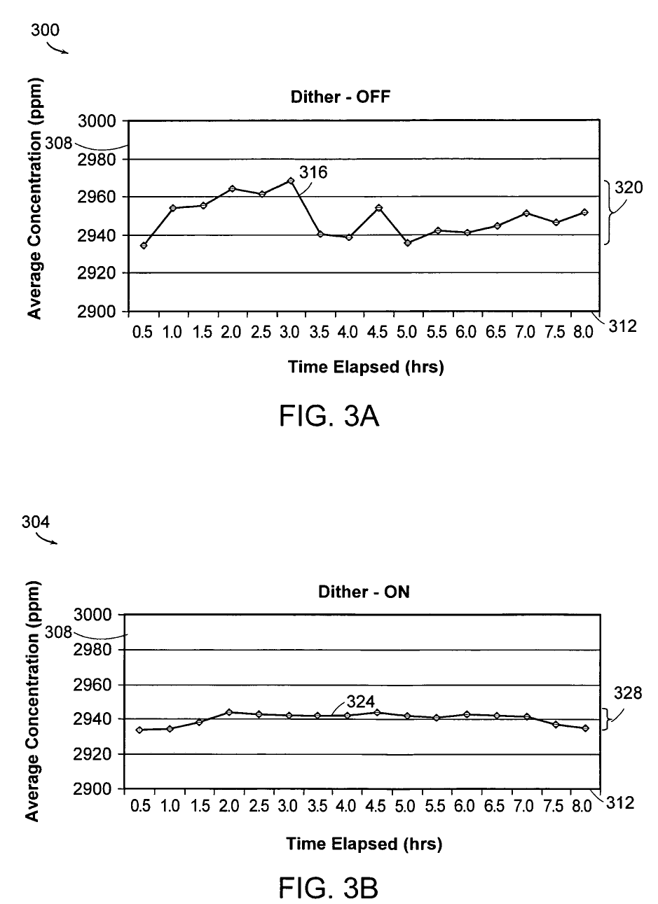

FIG. 3A illustrates a plot 300 of the average concentration of Nitric Oxide measured in the tank using the model 2030 Gas Analyzer, in the absence of the selected signal 172. The Y-Axis 308 of the plot 300 is the average concentration of Nitric Oxide in ppm. The X-Axis 312 of the plot 300 is the time at which measurements were made using the Gas Analyzer.

FIG. 3A shows that for measurements taken at 0.5 hour intervals, the Gas Analyzer measured an average concentration of Nitric Oxide which varied (shown by bracket 320) in value from a low value of about 2935 ppm to a high value of about 2970 ppm. The variability in measurement (2970 ppm-2935 ppm=35 ppm over the eight hour experiment) is attributed, in part, to the periodic nonlinearity effect of the non-uniform spacing of the quantization levels in the analog-to-digital converter (as illustrated, for example, in FIG. 3B). The analog-to-digital converter operated at a sampling rate of about 144,000 samples per second. The average of these measurements is approximately 2970 ppm over the eight hour experiment. The analog-to-digital converter is an 18 bit analog-to-digital converter that has a periodic nonlinearity whose period is 9 bits out of the 18 bit full-scale range of the analog-to-digital converter.

An initial calibration step is sometimes performed to calibrate the output of the Gas Analyzer so that the output of the Gas Analyzer matches the actual concentration of a reference sample. By way of example, in this embodiment, the average output of the Gas Analyzer (i.e., 2950 ppm) could be adjusted to match the actual concentration (e.g., specified by an operator to be 3020 ppm in this experiment) of the Nitric Oxide supplied to the tank.

FIG. 3B is also a plot 304 of the average concentration of Nitric Oxide measured in ppm versus time. The Y-Axis 308 of the plot 304 is the average concentration of Nitric Oxide in ppm. The X-Axis 312 of the plot 304 is the time at which measurements were made using the Gas Analyzer. The individual measurements of curve 324 of the plot 304 were measured using the same Gas Analyzer as was used to acquire the data for plot 300 of FIG. 3A. The measurements made for plot 304 of FIG. 3B were, however, made in the presence of a selected signal (for example, the selected signal 172 of FIG. 1), in a similar manner as described previously herein.

The measurements for curve 324 of FIG. 3B were take at approximately the same time as those taken for curve 316 of FIG. 3A. In this experiment, the selected signal 172 is a 65 kHz sinusoid with a magnitude of about 20 mV at the input to the analog-to-digital converter. In this embodiment, the magnitude (20 mvolts) of the selected signal is about twice the magnitude (2*9.8 mvolts) associated with the period (9 bits out of 18 bits with a full scale voltage range of 5 volts) of the periodic nonlinearity in the analog-to-digital converter. In the presence of the selected signal 172, the variation in the measured average concentration of Nitric Oxide is only about 10 ppm (shown as bracket 328). The curve 324 varies in value over the eight hour test from a low value of about 2935 ppm to a high value of about 2945 ppm.

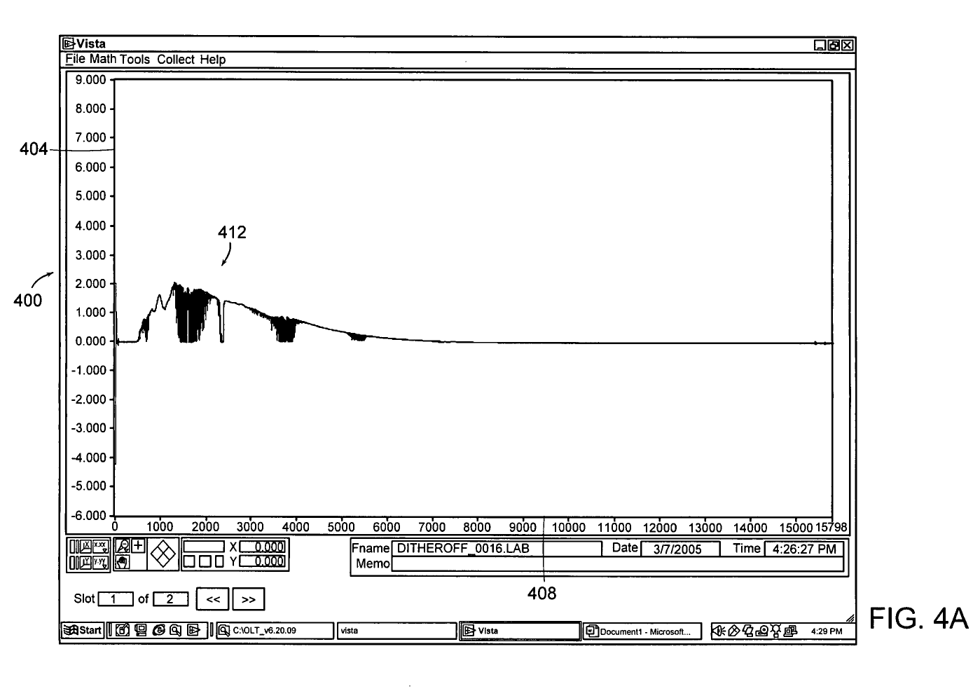

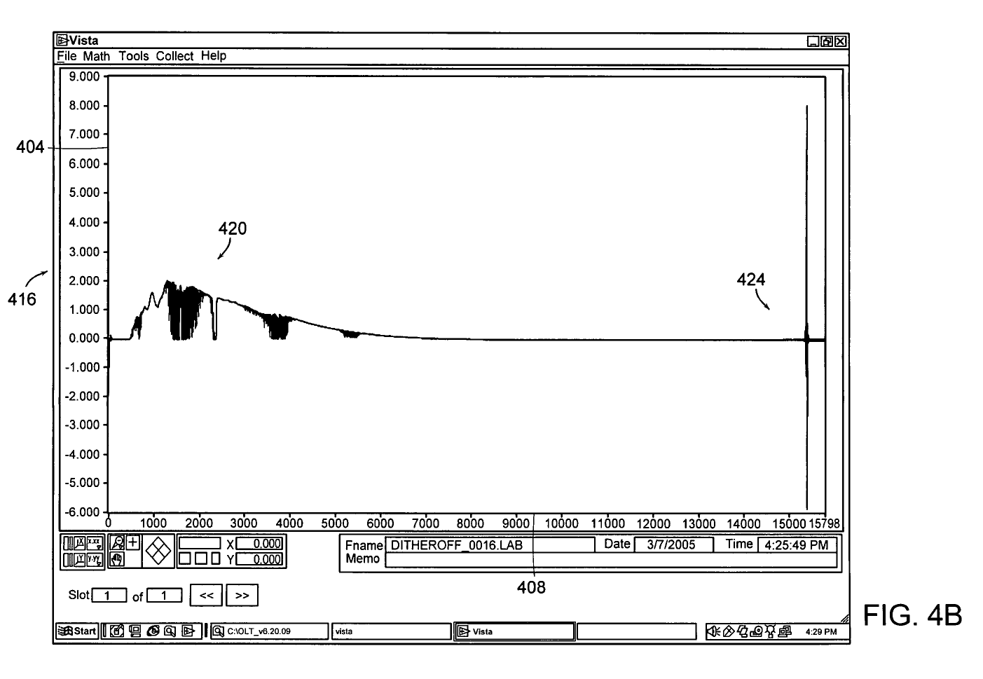

FIGS. 4A and 4B are graphical representations of spectrum computed using the Gas Analyzer discussed previously with respect to FIGS. 3A and 3B. FIG. 4A is a plot 400 of the light spectrum detected by the liquid N₂ cooled Mercury Cadmium Telluride detector. The Y-Axis 404 is a non-dimensional representation of the intensity of the optical spectrum as determined by the analyzer. The X-Axis 408 is the frequency of the spectrum in units of cm⁻¹. The non-zero portion 412 (bandwidth) of the Gas Analyzer's spectral range 412 is determined by the detailed optical characteristics of the analyzer, including (but not limited to) the source bandwidth, optical materials used for beamsplitters, lenses, windows, optical alignment, and detector cutoff. In this example, the absorption bands visible in the spectrum are those associated with the Nitric Oxide lying in the analyzer's active spectral range between about 700 cm⁻¹ and about 7,000 cm⁻¹.

FIG. 4B is a plot 416 of the light spectrum detected by the liquid N₂ cooled Mercury Cadmium Telluride detector in the presence of the selected signal previously described in FIG. 3B. The Y-Axis 404 is a non-dimensional representation of the intensity of the optical spectrum as determined by the analyzer. The active spectral range 420 of the analyzer depends upon its detailed optical characteristics as described above. The X-Axis 408 is the frequency of the spectrum in units of cm⁻¹. Visible in the spectrum are absorption bands associated with the Nitric Oxide lying in the analyzer's active spectral range between about 700 cm⁻¹ and about 7000 cm⁻¹. The feature in the spectrum located at about 15,500 cm⁻¹ is due to the selected signal (65 kHz sinusoid). In this embodiment, the fundamental and the harmonics of the selected signal (illustrated by the feature in the spectrum at about 15,500 cm⁻¹) are substantially outside the active spectral range of the instrument. In this manner, the fundamental and harmonics of the selected dither signal do not substantially affect the ability of the Gas Analyzer to be used in determining the presence and concentration of the Nitric Oxide in the sample.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An apparatus for measuring radiometric signals, comprising:
a source of infrared energy;
a first module for splitting the infrared energy into a first and second signal;
a second module for creating a path length difference in the first signal relative to the second signal;
a third module for combining the first signal with the second signal to create an interference signal and to direct the interference signal through a sample;
a fourth module for detecting the sample signal;
a signal source that outputs a selected signal capable of reducing the effect of analog-to-digital converter nonlinearity on measured radiometric signals;
a fifth module that combines the detected sample signal and the selected signal; and
an analog-to-digital converter that converts the combined detected sample signal and selected signal into a digital signal in which the effect of nonlinearity is substantially reduced.

2. The apparatus of claim I wherein the selected signal comprises one or more signals selected from the group consisting of a sinusoidal signal, sawtooth signal, triangular signal, slow constant ramp signal, and a band-limited white noise signal.

3. The apparatus of claim 1 wherein a fundamental and harmonics of the selected signal are substantially outside a bandwidth of frequencies associated with the sample signal.

4. The apparatus of claim 1 wherein the selected signal has a mean amplitude of substantially zero.

5. The apparatus of claim 1 wherein the selected signal is a pre-defined signal.

6. The apparatus of claim 1 wherein the selected signal is determined during operation of the apparatus.

7. The apparatus of claim 6 wherein the selected signal is determined during operation of the apparatus based on the sample signal.

8. The apparatus of claim 1 wherein the analog-to-digital converter is an 18 bit analog-to-digital converter and the period of the nonlinearity corresponds to 9 bits of the 18 bit analog-to-digital converter.

9. The apparatus of claim 8 wherein the selected signal is a sinusoid having a magnitude determined by the period of the nonlinearity.

10. The apparatus of claim 1, comprising a sixth module that removes a signal equivalent to the selected signal from the digital signal to generate a second digital signal.

11. The apparatus of claim 10 wherein the signal equivalent to the selected signal is removed in the time domain.

12. The apparatus of claim 10 wherein a transformed signal equivalent to the selected signal is removed in the frequency domain.

13. The apparatus of claim 10 wherein a transformed signal equivalent to the selected signal does not substantially affect measurement of radiometric signals.

14. The apparatus of claim 1 wherein the fifth module sums or combines the sample signal and the selected signal.

15. The apparatus of claim 1 wherein the sample is one or more of a solid, liquid or gas.

16. The apparatus of claim 1 wherein the nonlinearity is one or more of a periodic, integral, or differential nonlinearity.

17. An apparatus for measuring radiometric signals, comprising:
a source of radiant energy to direct radiant energy through a sample;
a first module for detecting the sample signal;
an analog-to-digital converter; and
a signal source that outputs a selected signal capable of reducing the effect of nonlinearity of the analog-to-digital converter when combined with the sample signal and converted by the analog-to-digital converter to create a first digital signal.

18. The apparatus of claim 17, comprising a second module for converting the analog-to-digital converter signal to a frequency domain signal.

19. The apparatus of claim 18 wherein the conversion to the frequency domain signal is accomplished by a Fourier Transform.

20. The apparatus of claim 18, comprising a third module that processes and correlates the frequency domain signal with a signal representative of a known material to identify the concentration of the known material in the sample.

21. The apparatus of claim 18, comprising a third module for at least one of quantifying or qualitatively determining at least one property of the sample.

22. The apparatus of claim 21 wherein the property is at least one property selected from the group consisting of concentration, temperature, pressure, and color.

23. The apparatus of claim 17 wherein the selected signal is a pre-defined signal.

24. The apparatus of claim 17 wherein the selected signal is determined during operation of the apparatus.

25. The apparatus of claim 17, comprising a second module that removes a signal equivalent to the selected signal from the first digital signal to generate a second digital signal.

26. The apparatus of claim 25 wherein the signal equivalent to the selected signal is removed in the time domain.

27. The apparatus of claim 25 wherein a transformed signal equivalent to the selected signal is removed in the frequency domain.

28. The apparatus of claim 25 wherein a transformed signal equivalent to the selected signal does not substantially affect measurement of radiometric signals.

29. A method for measuring radiometric signals, comprising:
splitting an infrared source signal into a first and second infrared signal;
propagating the first and second infrared signals over different, adjustable, time-varying path lengths;
combining the first and second propagated infrared signals to generate an interference signal;
directing the interference signal through a sample;
detecting the interference signal that has passed through the sample;
combining a selected signal capable of reducing the effect of analog-to-digital converter nonlinearity on measured radiometric signals, with the detected sample signal to create a third signal; and
converting the third signal into a digital signal in which the effect of nonlinearity is substantially reduced.

30. The method of claim 29, comprising removing a signal equivalent to the selected signal from the digital signal to generate a second digital signal.

31. The method of claim 29, comprising selecting a selected signal having a fundamental and harmonics substantially outside a bandwidth of frequencies associated with the sample signal.

32. The method of claim 29 wherein the selected signal is a pre-defined signal.

33. The method of claim 29, comprising determining the selected signal during operation.

34. The method of claim 29, comprising removing a signal equivalent to the selected signal from the digital signal to generate a second digital signal.

35. The method of claim 29, comprising removing in the time domain a signal equivalent to the selected signal from the digital signal to generate a second digital signal.

36. The method of claim 29, comprising removing in the frequency domain a transformed signal equivalent to the selected signal from the digital signal to generate a second digital signal.

37. A method for measuring radiometric signals, comprising:
directing radiant energy through a sample;
detecting the sample signal;
combining a selected signal capable of reducing the effect of analog-to-digital converter nonlinearity on measured radiometric signals, with the detected sample signal to create a first signal; and
converting the first signal into a digital signal in which the effect of nonlinearity is substantially reduced.

38. The method of claim 37, comprising converting the digital signal into a frequency domain signal.

39. The method of claim 37 wherein the conversion to the frequency domain is accomplished by a Fourier Transform.

40. The method of claim 39, comprising processing the frequency domain signal with a signal representative of a known material to identify the concentration of the known material in the sample.

41. The method of claim 37, comprising at least one of quantifying or qualitatively determining at least one property of the sample.

42. The method of claim 37, comprising pre-defining the selected signal.

43. The method of claim 37, comprising selecting the selected signal during operation.

44. The method of claim 37, comprising removing a signal equivalent to the selected signal from the digital signal to generate a second digital signal.

45. The method of claim 37, comprising removing in the time domain a signal equivalent to the selected signal from the digital signal to generate a second digital signal.

46. The method of claim 37, comprising removing in the frequency domain a transformed signal equivalent to the selected signal from the digital signal to generate a second digital signal.

47. The method of claim 37, comprising averaging the digital signal measured at two or more different times.

48. An apparatus for measuring radiometric signals, comprising:
a source of infrared energy;
a first means for splitting the infrared energy into a first and second signal;
a second means for creating a path length difference in the first signal relative to the second signal;
a third means for combining the first signal having a path length difference with the second signal to create an interference signal and to direct the interference signal through a sample;
a fourth means for detecting the sample signal;
a fifth means for outputting a selected signal capable of reducing the effect of analog-to-digital converter nonlinearity on measured radiometric signals;
a sixth means for combining the detected sample signal and the selected signal; and
an analog-to-digital converter that converts the combined detected sample signal and selected signal into a digital signal in which the effect of nonlinearity is substantially reduced.

49. A method for improving the accuracy of analog-to-digital converters, comprising:
combining a selected signal that is capable of reducing the effect of analog-to-digital converter periodic nonlinearity, with an analog signal that is to be converted by an analog-to-digital converter, wherein characteristics of the selected signal are selected so that a fundamental and harmonics of the first signal are substantially outside a bandwidth of frequencies associated with the analog signal;
directing the combined signal to an input of an analog-to-digital converter; and
converting the combined signal into a digital signal.

50. The method of claim 49 wherein the selected signal is a signal selected from the group consisting of a sinusoidal signal, sawtooth signal, triangular signal, slow constant ramp, and a band-limited white noise signal.

51. The method of claim 49 wherein the bandwidth of frequencies is a pre-determined bandwidth of frequencies.

52. The method of claim 49 wherein the selected signal is summed with the analog signal.

53. The method of claim 49 wherein the selected signal is combined with the analog signal.

54. The apparatus of claim 49 wherein the selected signal is a pre-defined signal.

55. The apparatus of claim 49 wherein the selected signal is determined during operation.
